(19) United States
(12) Patent Application Publication
(10) Pub. No.: US 2003/0084602 A1
(43) Pub. Date: May 8, 2003

(54) Self-sinking lure

(76) Inventor: Herb Reed, Southington, CT (US)

Correspondence Address: McCormick, Paulding & Huber LLP, CityPlace II, 185 Asylum Street, Hartford, CT, 06103-3402, US

(21) Appl. No.: 10/011,074

(22) Filed: Nov. 7, 2001

(51) Int. Cl. A01K 85/00

(52) U.S. Cl. 43/42.39

(57) ABSTRACT

A fishing lure having one or more stationary weights, at least partially encapsulated during the manufacturing process within a flexible body portion or appendages thereof, and independent of any mechanical connection to the hook, line, line tie, or any wire harness or frame which may be incorporated into the lure, is presented. The one or more weights are of a material that is insoluble in water.

### FIELD OF THE INVENTION

This invention relates to fishing lures in general, and to weighted, flexible bodied fishing lures in particular.

### BACKGROUND

The specific gravity of materials typically used to fashion flexible bodied fishing lures such as plastic worms, preyfish, crawfish, frogs, shrimp, squid, etc. is less than, or very close to, that of water (specific gravity 1.0) causing them to float or descend very slowly unless weight(s) are attached to the lure, hook or line. Under some fishing circumstances, this is a desirable attribute. Under other conditions, it is not.

In cases where a lure that descends more quickly is desirable, additional weight must be added or incorporated into the lure. Adding weight to the line, or to the hook ahead of, or at the front of the lure to cause it to sink and affects the attitude of the lure body as it sinks, giving the lure a “nose first” attitude. While this may be desirable in certain lures, such is not always the case. Often, in the prior art, small lures are difficult to cast without head or line weights attached thereto.

Moreover, where a jig head is used to add weight to a lure with a flexible body the weighted lead head is metallic and therefore hard. Fish striking at the lure are more apt to reject it due to the unnatural feel of the hard head. Furthermore, because a jig head is by its nature a weight molded onto a hook, it limits the rigging possibilities, as regards to the placement of the weight in relation to the body of the lure and the hook. In addition, the use of externally exposed fishing weights create an unnatural appearance that tends to wary fish from striking the lure.

Based on the forgoing, it is the general object of the present invention to provide a lure or lures that overcomes the drawbacks of prior art soft or flexible bodied fishing lures.

### SUMMARY OF THE INVENTION

The present invention is directed in one aspect to a fishing lure having a flexible body portion and at least one independent weight, insoluble in water. The weight is at least partially encapsulated within the lure and is stationary relative thereto. As used herein the term “flexible” is to be construed to mean that the material from which the body portion of the lure made is flexible and elastomeric or polymeric. Further, the term “body portion” shall be construed as meaning the lure, including any appendages extending from it.

In an embodiment of the present invention, there are a plurality of weight(s), at least some of which are partially encapsulated in the body portion of the lure. Alternatively, the weight(s) can all be completely encapsulated in the lure. Preferably, the flexible embodiment is formed of a polymer or elastomer.

An advantage of the present invention is that the lure is self sinking with the weights within the lure being locatable during the manufacturing process, to provide for variety of different swimming/descending attitudes as the lure moves through the water, and as it rests on the bottom or floor of the water body, by controlling, through position, distribution, size and weight of the encapsulated weight(s), the center of gravity on all axes, weight distribution and the overall specific gravity of the lure itself. The present invention lure also provides weight management for lure descent control. The weights can be positioned to overcome water resistance inherent in particular designs or shapes of lures which sink, descend or maneuver otherwise dependant on points of least resistance. Additionally, the present invention positioning of the weight(s) at least partially interior the body portion of lures provides for the design of small lures to be heavier, thus enhancing the casting and maneuverability of smaller lures.

The weight or weights are positioned in the lure independent of the hook, the angling line and any wire form or harness connecting the two. Therefore, considerations involved in the placement of the weights involve the way in which they affect the lure's attitude as it moves through the water or as it rests on the floor of the body of water in which it is being used, and how the lure actually moves through water both when it is being pulled and when it is drifting free or descending.

Encapsulating the weight at least partially interior the body portion or appendages of the lure provide a natural look and feel to the fish. Furthermore, the present invention soft lure provides an angler with self contained weighted lures eliminating the need for rigging weights thereto, thus simplifying and removing additional parts/steps to the angling process and the presentation of the lure.

The weight(s) can be positioned at least partially interior the body portion of the lure or completely interior the body portion of the lure using a flexible material or substantially flexible material to attach the weight(s) one to the other or otherwise position or secure them during the process of manufacturing the body portion of the lure. This positioning of the weights interior the lure or partially interior the lure may be used as part of the design of the lure to obtain the desired attitude of the lure as described hereinabove. The flexible material used to attach the weight(s) together or otherwise position or secure or them during the manufacturing process can be made of the same material as the body portion of the lure such that the material blends with the body portion of the lure and is not visible once the manufacturing process is complete. Alternatively, the material used to attach together or otherwise position or secure the weights during the manufacturing process could be any plastic, polymer, elastomer, nylon or other suitable flexible or substantially flexible material as long as the material used does not substantially alter the characteristics of the flexible lure body.

### BRIEF DESCRIPTION OF THE DRAWINGS

FIG. 1 is a perspective view of one embodiment of the present invention, a portion of which is cut away to expose a weight;

FIG. 2 is a side elevational cross-section view taken along line 2-2 of FIG. 1;

FIG. 3 is a cross sectional view taken along line 3-3 of FIG. 1;

FIG. 4 is a perspective view of another embodiment of the present invention, this one of a legged creature, in which the weight(s) are encapsulated in the legs. A portion of one leg is cut away to expose a weight;

FIG. 5 is a side elevational cross section view of a lure shape with weights encapsulated in a specific section of the lure to ensure that when allowed to rest on or come in contacts with the bottom or floor of the water body, an exposed hook point above the lure's “top” surface does not come into contact with said bottom;

FIG. 6 is a cross section taken along line 6-6 of FIG. 5;

FIG. 6A is cross section view of an embodiment of the present invention similar to the FIG. 5 embodiment showing the weights attached together;

FIG. 7 is a perspective view of an embodiment of the present invention formed in a shape representative of a squid, built with a substantially hollow main body portion, and equipped with encapsulated weights positioned as to force said lure to maintain an attitude that is substantially at odds with that it would assume lacking said weights;

FIG. 8 is a longitudinal cross section of the embodiment illustrated in FIG. 7;

FIG. 9 is a lateral cross section of the embodiment illustrated in FIGS. 7 and 8, taken along line 9-9 in FIG. 8;

FIG. 10 is a top view of an abstract or fanciful lure design incorporating a single weight that is partially encapsulated in the lure;

FIG. 11 is a side elevation cross section of the embodiment illustrated in FIG. 10;

FIG. 12 is a longitudinal cross section of an embodiment of the present invention fashioned in the shape of the lure style commonly referred to as a “tube”, with a weight encapsulated in the body portion of the lure—specifically within the wall of the tubular shape;

FIG. 13 is a cross section of the embodiment illustrated in FIG. 12, taken across line 13-13; and

FIG. 14 is a side elevational view of an embodiment of the present invention comprising a spinner attached to the lure.

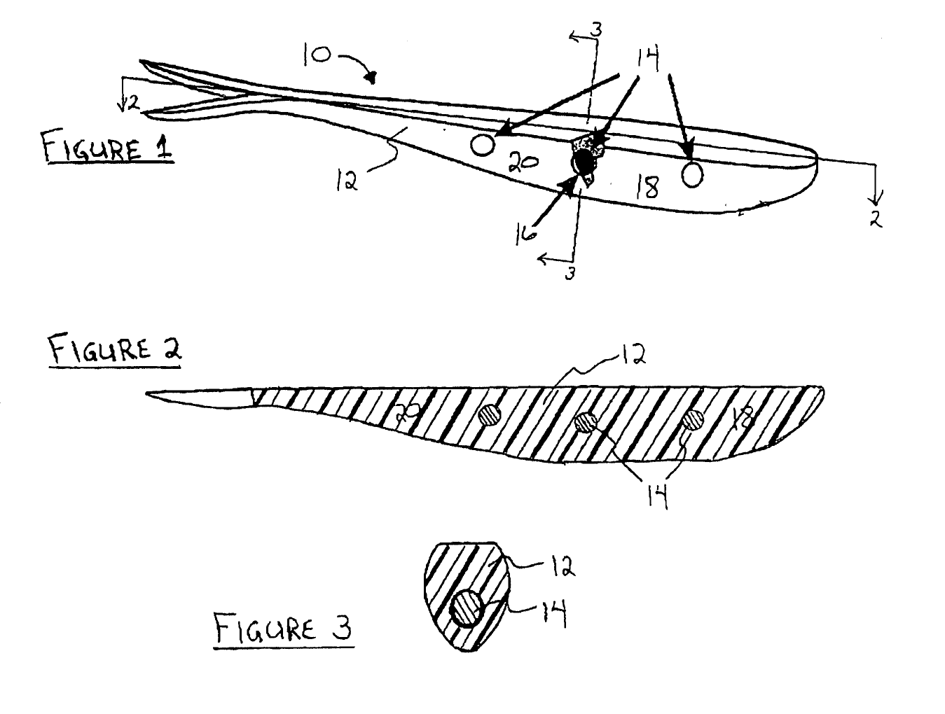

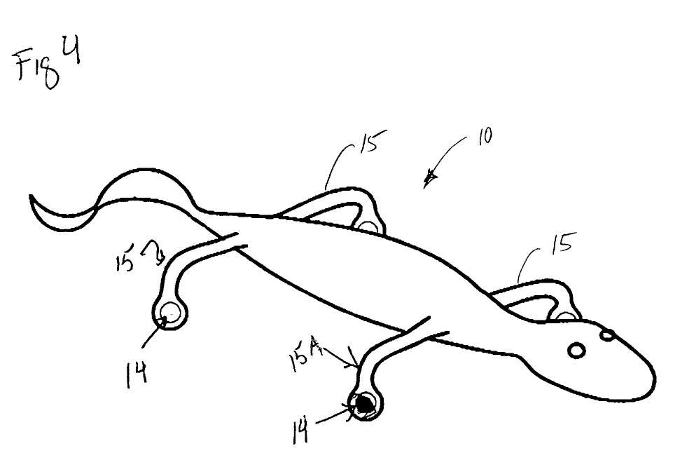

### DETAILED DESCRIPTION

As shown in FIG. 1, a lure generally designated by the reference number 10, includes a flexible body portion 12. The flexible body portion 12 is formed from a suitable polymeric or elastomeric material, such as, but not limited to, latex, vinyl, plastisol or other flexible materials known to those skilled in the pertinent art to which the present invention pertains. The lure 10 may be shaped to represent a preyfish as shown, an invertebrate, crustacean, amphibian, reptile, or any of an infinite variety of shapes, natural or fanciful.

Referring to FIG. 2, a series of independent weights 14 are shown positioned within the flexible body portion 12 of the lure 10. In the illustrated embodiment, these weights are completely encapsulated within the flexible body portion 12, and are stationary relative thereto. However, the present invention is not limited in this regard as in other embodiments, some or all of the weights can also be partially protruding from the body itself. As used herein, the term “independent” is construed to mean independent of mechanical connection to a hook, line, line tie, or any wire harness or frame that may be incorporated into the lure as a portion of or an extension to the angling line. As mentioned above and show in FIG. 6A, the weight(s) may be attached one to the other or otherwise positioned or secured using a flexible or substantially flexible material during the process of manufacturing the body portion of the lure, however, if present, this material is not attached to the angling line or harness and does not detract from the independent effect each weight has relative to the body portion of the lure. The FIG. 6A embodiment shows the material used to attach the weights together as visible relative to the body portion of the fish, however, the flexible material used to attach the weights together can be the same or similar to the material used to manufacture the body portion of the lure such that it is not visibly discernable from the body portion.

Referring again to FIG. 2, the weights 14 shown in the illustrated embodiment are spaced apart from one another and spread somewhat evenly along the length of the flexible body portion 12. However, the present invention is not limited in this regard as the weight(s) may be positioned in any desired manner. For example, it may be necessary to concentrate a portion or all of the weights in a specific area of the lure to achieve a desired attitude in the water. In addition, while a fish shaped lure has been shown, the present invention is not limited in this regard, as other shapes, such as, but not limited to, frogs, crustacea, worms, reptiles, etc., as well as fanciful shapes such as shown in FIG. 4, can be used without departing from the broader aspects of the present invention.

Turning to FIG. 4, a lure embodiment with appendages 15 in the form of “legs” is shown. The encapsulated weight(s) 14 are in these appendages rather than interior the torso section of the lure body 10. Leg 15-A is shown partially cut-away to more clearly illustrate the placement of the weight therein. In FIG. 4, four legs 15 are shown. In practice, any number of such appendages might be included in a lure design, and the encapsulated weight(s) could be positioned in any or all of them, and in the torso as well, dependent on design considerations and the desired effect on the lure's attitude and movement through the water or across the bottom of the body of water.

FIGS. 5 and 6 detail an embodiment of the present invention lure generally 10 in which the weights 14 are encapsulated in the body section beneath a horizontal axis X-X of the lure. In this embodiment the weights 14, combine with a lower specific gravity and greater mass of the upper portion of the flexible lure body 10 to influence the way the lure comes to rest when allowed to settle on the floor of a body of water. The flexibility in positioning of the weights throughout the body, appendages or otherwise in the present invention lure provide a lure designer with a means to control the lure's position on the floor of the body of water or otherwise control the motion or mobility of the lure as it moves through the water. Furthermore, the present invention allows the designer to also effect the position of the hook 17, whether built into the lure at time of manufacture or rigged at the time of use by the angler, to maintain a position free of contact with the bottom of a lake or other body of water, or such objects as may be found thereon, thereby eliminating a potential cause of so-called “snags” wherein the hook becomes entangled with the bottom or other objects thereon and prevents or interferes with retrieval of the lure.

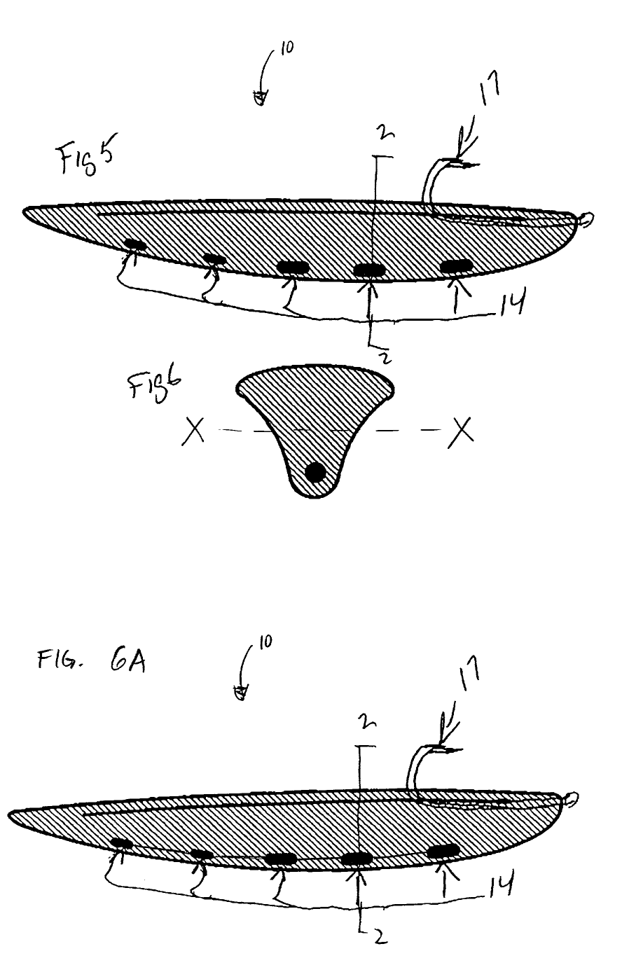

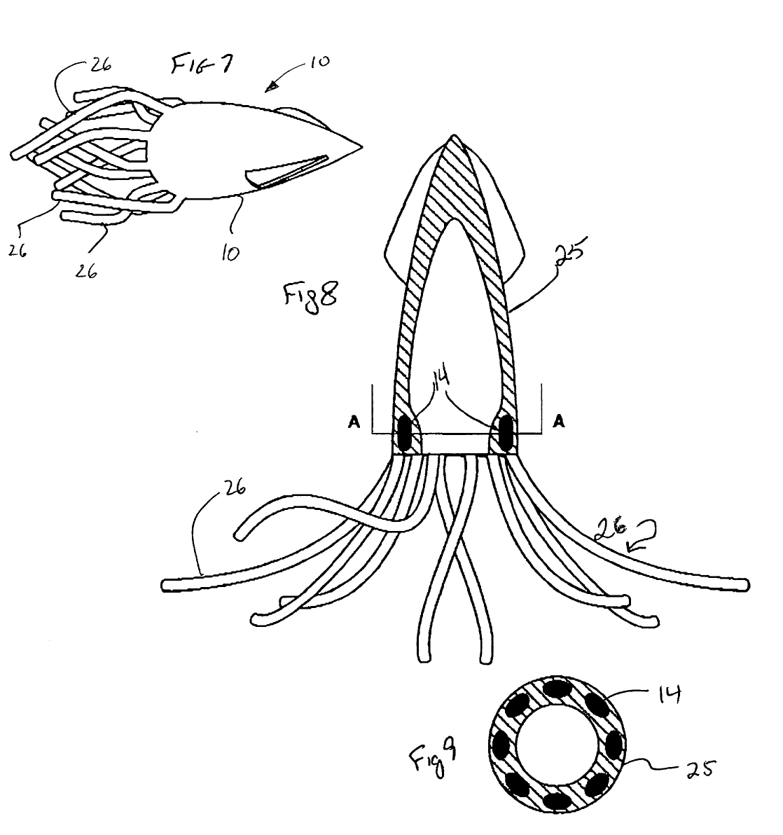

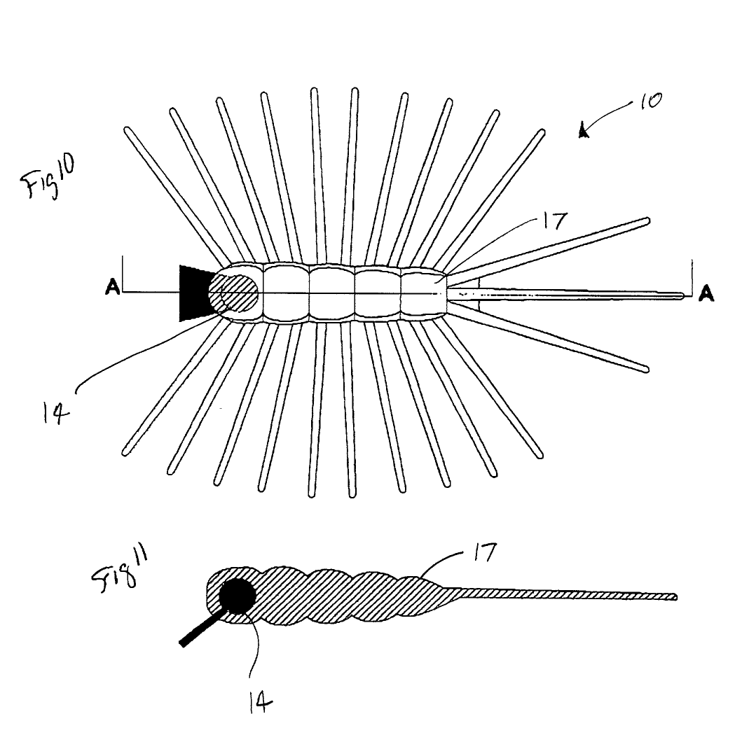

FIG. 7 illustrates a flexible fishing lure 10 formed in the general shape of a squid, consisting of a substantially hollow body 25 and trailing tentacles 26. The longitudinal cross section of the FIG. 7 embodiment, shown in FIG. 8, illustrates an application of the present invention to this shape, wherein weights 14 are encapsulated near the trailing edge of a hollow body section 25 of the lure 10. The weights 14 work to overcome water resistance as the lure 10 sinks through the water, giving the lure 10 a “nose up” attitude not unlike the natural descent position of a feeding squid. FIG. 9 shows a cross-sectional view of the FIG. 7 embodiment of lure 10 taken at line A-A of FIG. 8. FIG. 10 illustrates a fanciful lure design in which a single weight 14 is partially encapsulated within body 17 of the lure 10. FIG. 11 diagrams a side elevation cross-sectional view of the FIG. 10 embodiment taken at line A-A. The portion of the weight extending beyond the outer dimension of the lure body is fashioned as a blade or lip to add water resistance. The present invention is not limited in this regard however, and any exposed portion of the weight(s) anchored by encapsulating part of it within a lure body might assume any shape that the lure designer sought to incorporate.

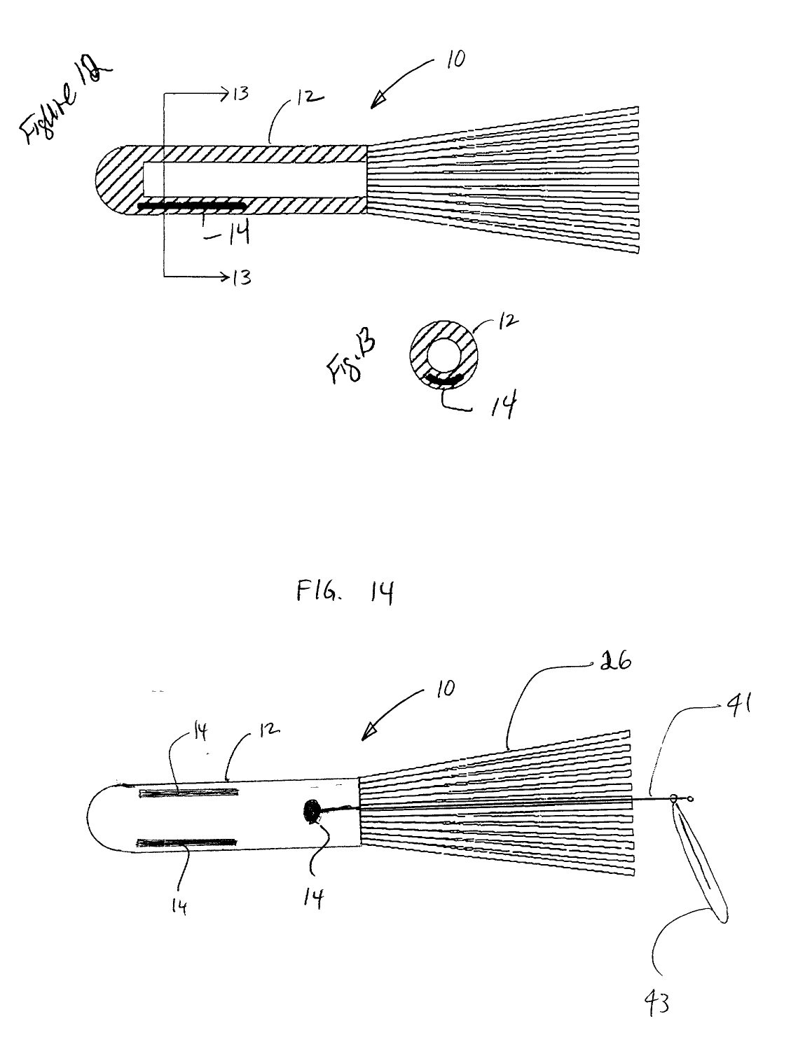

FIGS. 12 and 13 illustrate an embodiment of the present invention fashioned in the shape of the lure style commonly referred to as a “tube”. In the case of the present invention a weight 14 is encapsulated in the body portion 12 of the lure 10, specifically within the wall of the tubular shape of the body portion 12. FIG. 13 is a cross section of the embodiment illustrated in FIG. 12, taken across line 13-13. While one weight is shown in the illustration, the invention is not limited in this regard, as additional weights could be incorporated, either on the opposite side of the tubular shape, or at additional positions throughout the body portion 12 either completely or partially encapsulated therein. The shape of the weight 14 in this embodiment illustrates that the weights may be shaped and/or sized to fit within the available space provided by the body shape of any flexible bodied fishing lure.

Referring to FIG. 14, an embodiment of the present invention lure 10 is shown having a spinner 43 attached to the body portion 12 thereof via a connector 41. The connector 41 is attached to and extending from a weight 14 disposed interior the body portion 12 of the lure. In this embodiment the appendages 26 are attached to and extend outwardly from the body portion 12 of the lure. FIG. 14 is provided as an example only, as it will be obvious to one skilled in the art, that the spinner 43 could be substituted with any type of extension or device known in the art for attracting fish. Accordingly, the connector 41 is also shown for example only as other coupling means could be utilized to attach a fish attracting device to the lure body 12 such as nylon line, wire, a coupler, or connecting device.

While preferred embodiments have been shown and described, various modifications and substitutions may be made thereto without departing from the spirit and scope of the invention. Accordingly, it is to be understood that the present invention has been described by way of illustration and not limitation.

What is claimed is:

1. A fishing lure comprising:
a flexible body portion;
at least one weight at least partially encapsulated within said flexible body portion and stationary relative thereto; and
wherein said at least one weight being insoluble in water.

2. A fishing lure as defined in claim 1 wherein said at least one weight is completely encapsulated in said flexible body.

3. A fishing lure as defined in claim 1 wherein said body portion is elastomeric.

4. A fishing lure as defined in claim 1 wherein said body portion is polymeric.

5. A fishing lure as defined in claim 1 wherein said body portion is shaped in such a manner that portions of it form appendages, some or all of which may encapsulate one or more independent weights.

6. A fishing lure as defined in claim 1 further comprising coupling means for attaching a fish attracting device to said body portion of said lure.

7. A fishing lure as defined in claim 6 wherein said coupling means is attached to at least one of said weights.

8. A fishing lure comprising:
a flexible body potion;
a plurality of independent weights, each said weight being at least partially encapsulated in said body portion and stationary relative thereto; and
wherein each of said weights is insoluble in water.

9. A fishing lure as defined in claim 8 further comprising one or more appendages attached to said body portion wherein said weights are at least partially encapsulated in said body portion or said appendages and stationary relative thereto.

10. A method of manufacturing a fishing lure comprising the steps of:
defining a body portion of said lure;
positioning at least one weight for encapsulating at least a portion thereof interior said body portion; and
forming said body portion of said lure using a suitable material therefor.

11. The method as defined in claim 10 wherein said material is selected from the group consisting of plastic, polymer, elastomer, and nylon.

12. The method as defined in claim 10 wherein said body portion further comprises at least one appendage extending therefrom.

13. The method as defined in claim 10 wherein the step of positioning at least one weight further comprises the steps of:
positioning said at least one weight in a predetermined position for encapsulating at least a portion thereof interior said body portion of said lure.

14. The method as defined in claim 13 further comprising the steps of:
calculating the desired movements and resting positions of the lure;
determining said position of said weight based on said calculations and the size and shape of the lure.

15. The method as defined in claim 14 further comprising the step of:
positioning a coupling or hooking device for encapsulating at least a portion thereof interior said body portion of said lure.

16. The method as defined in claim 10 wherein said at least one weight is a plurality of weights, the method further comprising the steps of:
attaching at least a portion of said weights together for securing said positioning of said weights during the manufacturing of said lure.

17. The method as defined in claim 16 wherein said step of attaching said weights together includes using a substantially flexible material.

18. The method as defined in claim 17 wherein said substantially flexible material comprises the material used to form said body portion of the lure.

19. The method as defined in claim 12 wherein the step of positioning at least one weight further comprises the steps of:
positioning said at least one weight in a predetermined position for encapsulating at least a portion thereof interior said body portion or said at least one appendage of said lure.

20. The method as defined in claim 19 further comprising the steps of:
calculating the desired movements and resting positions of the lure;
determining said position of said weight based on said calculations and the size and shape of the lure.

21. The method as defined in claim 12 wherein said at least one weight is a plurality of weights, the method further comprising the steps of:
attaching at least a portion of said weights together for securing said positioning of said weights during the manufacturing of said lure.

22. The method as defined in claim 21 wherein said step of attaching said weights together includes using a substantially flexible material.
